(19) United States
(12) Patent Application Publication
(10) Pub. No.: US 2005/0155452 A1
(43) Pub. Date: Jul. 21, 2005

(54) Bicycle pedal and cleat

(76) Inventor: Allen David Frey, Essex Jct., VT (US)

Correspondence Address: JAMES MARC LEAS, 37 BUTLER DRIVE, S. BURLINGTON, VT, 05403, US

(21) Appl. No.: 11/039,184

(22) Filed: Jan. 19, 2005

Related U.S. Application Data
(60) Provisional application No. 60/537,757, filed on Jan. 20, 2004.

(51) Int. Cl. G05G 1/14

(52) U.S. Cl. 74/594.6

(57) ABSTRACT

An assembly comprises a cleat and a pedal. In one embodiment the pedal includes a locking structure and a retaining wall. The locking structure is capable of locking the cleat to the pedal. The retaining wall prevents the cleat from sliding off the pedal when the cleat is not locked in the locking structure. In one embodiment the pedal includes a removable platform and a pedal body. The removable platform includes the locking structure, and this platform is removable from the pedal body when a sufficient force is applied, allowing for a quick disconnection in an emergency.

### RELATED APPLICATIONS

This application claims priority of Provisional Patent Application 60/537,757, filed Jan. 20, 2004, incorporated herein by reference.

### FIELD

This patent application generally relates to an improved cleat for pedaling a bicycle or other pedal driven device.

### BACKGROUND

Clips for bicycle pedals substantially improved pedaling efficiency by preventing relative vertical motion between the cleat and the pedal. Clipless pedals that connect to special cleats that are part of a rider's shoe were a further improvement because they were easier to engage than standard clips and they do not rub against the ground when not in use. However, none of the pedals have been sufficiently easy to disengage from, particularly in an emergency, to avoid injury. Thus, many riders have fallen and been hurt because at least one foot was locked into their clipless pedals. Nor has there been a satisfactory way to maintain the cleat on the pedal when the cleat was not locked into the pedal. A solution to these problems is provided here.

### SUMMARY

In one aspect, an assembly includes a cleat and a pedal. The pedal includes a locking structure and a retaining wall. The locking structure is capable of locking the cleat to the pedal. The retaining wall extends to block the cleat from sliding off the pedal when the cleat is resting on the pedal but is not locked in the locking structure.

In one embodiment the locking structure includes a twistable locking structure, wherein the twistable locking structure locks the cleat to the pedal when the cleat is twisted in a first direction and unlocks the cleat from the pedal when the cleat is twisted in a second direction opposite to the first direction.

In one aspect the locking structure includes a slot, wherein the cleat includes an engaging hook that fits in the slot, wherein twisting the cleat with respect to the locking structure causes the engaging hook to be locked to the locking structure.

The slot can have a first section with a first radius and a second section with a second radius, wherein the cleat fits in the first section, wherein the twisting causes the hook to be captured.

The engaging hook may have a J shaped region. Location of the engaging hook on the cleat is adjustable. The pedal can include a pedal surface for receiving the engaging hook.

In one aspect, the pedal includes a pedal body, a removable platform, and a spring loaded quick release mechanism there between. The quick release mechanism is for releasably connecting the removable platform to the pedal body, wherein the quick release mechanism releases the removable platform from the pedal body when a sufficient force is applied. The spring loaded release mechanism can include an adjustable spring.

The pedal can further include a pedal body and a quick release mechanism, the quick release mechanism for disengaging the cleat from the pedal body while the cleat remains locked to the locking structure. The quick release mechanism may comprise a removable platform. The quick release mechanism can further comprise a spring, wherein the removable platform is spring loaded to the pedal body with the spring. The quick release mechanism can further include a screw for adjusting spring tension of the spring. The quick release mechanism can further include a ball catch that engages in a recess in the pedal body and is held in the recess with the spring tension.

In one aspect, the pedal includes a pedal surface, the locking structure extending below the pedal surface, the retaining wall extending above the pedal surface. The pedal further may include a pedal body and a removable platform releasably connected to the pedal body, the surface being a surface of the removable platform. The removable platform can include the locking structure. The retaining wall may comprise a ring shaped wall. The retaining wall may extend fully around the pedal.

In one embodiment, the cleat has an outside dimension and the retaining wall has an inner dimension, wherein the outside dimension is about equal to or less than the inner dimension. The outside dimension and the inner dimension may be set to prevent sliding of the cleat in the pedal while permitting rotation of the cleat in the pedal.

Another embodiment includes a cleat and a pedal, wherein the pedal includes a pedal body, a removable platform, and a releasing mechanism there between. The removable platform is releasably connected to the pedal body, and the releasing mechanism is set to release the platform from the pedal body when a sufficient force is applied.

An adjusting mechanism may be provided for changing magnitude of force sufficient to release the removable platform from the pedal body.

In one aspect the releasing mechanism includes a spring and a ball catch. The platform can further include a cleat locking and unlocking structure.

Another embodiment includes a cleat and a pedal, wherein the pedal includes a surface having a cleat locking and unlocking structure that includes a dual width slot.

In another aspect, the pedal further comprises a pedal body, a removable platform, and a quick release mechanism. The surface is a surface of the platform, the quick release mechanism disconnects the platform from the pedal body when a sufficient force is applied. The quick release mechanism can include a spring loaded device. The quick release mechanism can include an adjusting screw for adjusting spring tension of the spring loaded device. The quick release mechanism can include a ball catch.

In another embodiment, a bicycle cleat and pedal assembly includes a cleat and a pedal, a first retaining mechanism and a second retaining mechanism. The first retaining mechanism locks the cleat to the pedal. The second retaining mechanism holds the cleat on the pedal when the first mechanism is not used.

In one aspect, the second mechanism permits relative rotation between the cleat and the pedal and prevents the cleat from sliding off the pedal.

### BRIEF DESCRIPTION OF DRAWINGS

FIG. 1A is a three dimensional exploded view of an embodiment of a twist to lock pedal clip;

FIG. 1B is another three dimensional exploded view of the embodiment of FIG. 1;

FIG. 2A is a three dimensional view of the embodiment of FIG. 1 showing the clip in unlocked position;

FIG. 2B is a three dimensional view of the embodiment of FIG. 1 showing the clip in a position wherein the cleat is ready to drop down into the clip;

FIG. 2C is a three dimensional view of the embodiment of FIG. 1 showing the clip in a position wherein the cleat has dropped down into the clip and is ready to be twisted to lock in;

FIG. 2D is a three dimensional view of the embodiment of FIG. 1 showing the clip in a position wherein the cleat has dropped down into the clip and has been twisted to lock in;

FIG. 3 is a cross sectional view of the platform; and

FIG. 4 is a three dimensional view of the embodiment of FIG. 1 with the clip in a locked position and with a pop out safety plate activated.

### DETAILED DESCRIPTION

Locking a cleat to a pedal prevents perpendicular movement between pedal surface and cleat, improving pedaling efficiency. An improved two-sided bicycle pedal is provided that permits a cleat to be quickly locked to or unlocked from either side of a pedal. The cleat, attached to the rider's shoe, is locked to the pedal by the rider by twisting the cleat with respect to the pedal. The cleat is unlocked from the pedal by twisting in the opposite direction. An elevated retaining structure prevents the cleat from sliding off the pedal when the cleat is not locked in. The pedal also includes a mechanism allowing a portion of the pedal and the cleat to disengage from the rest of the pedal in an emergency.

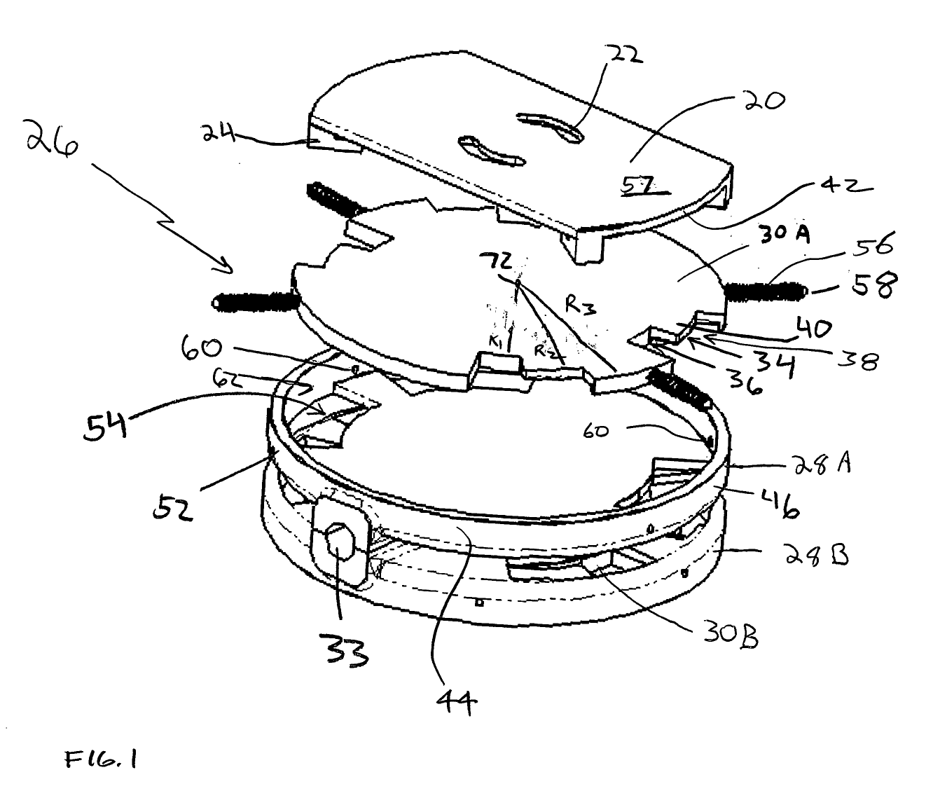

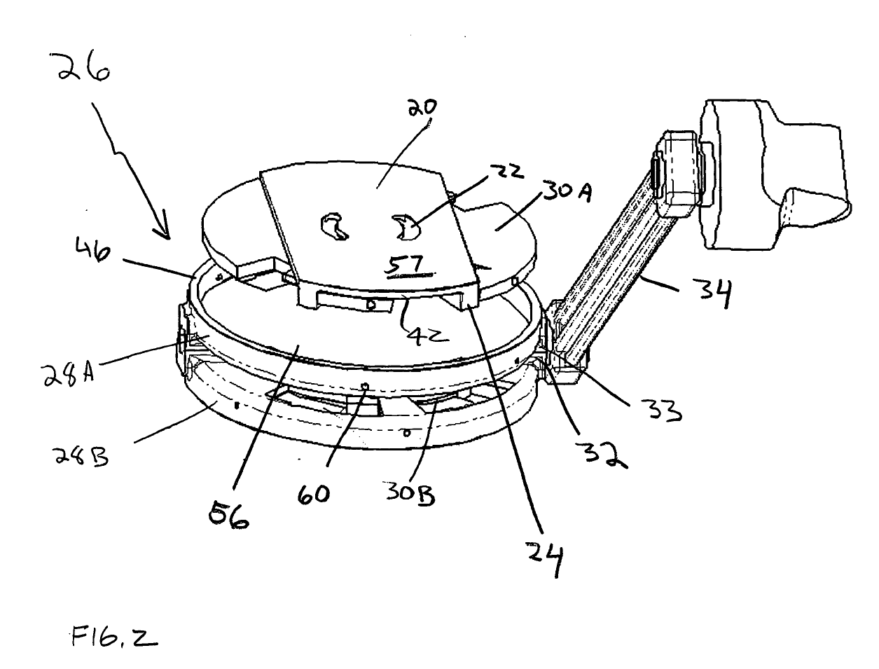

Cleat 20 includes mounting slots 22, as shown in FIG. 1a, for connecting cleat 20 to a shoe (not shown). Cleat 20 can be connected to the shoe with screws, and its position on the shoe can be adjusted as provided by slots 22.

Cleat 20 also includes engaging hooks 24 for releaseably connecting cleat 20 to pedal 26. Four such engaging hooks 24 are provided in the embodiment shown in FIG. 1a.

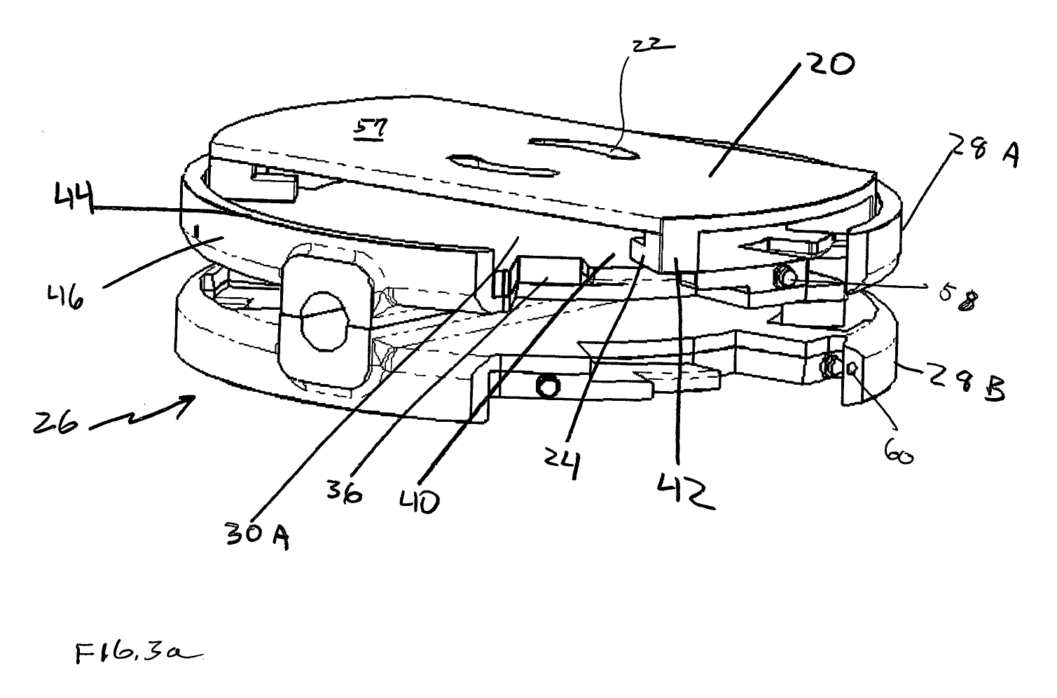

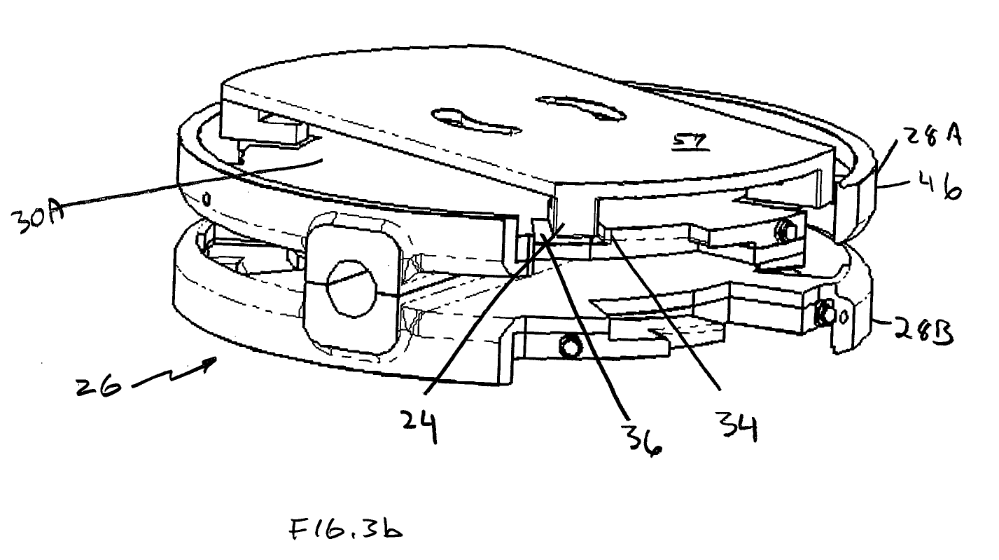

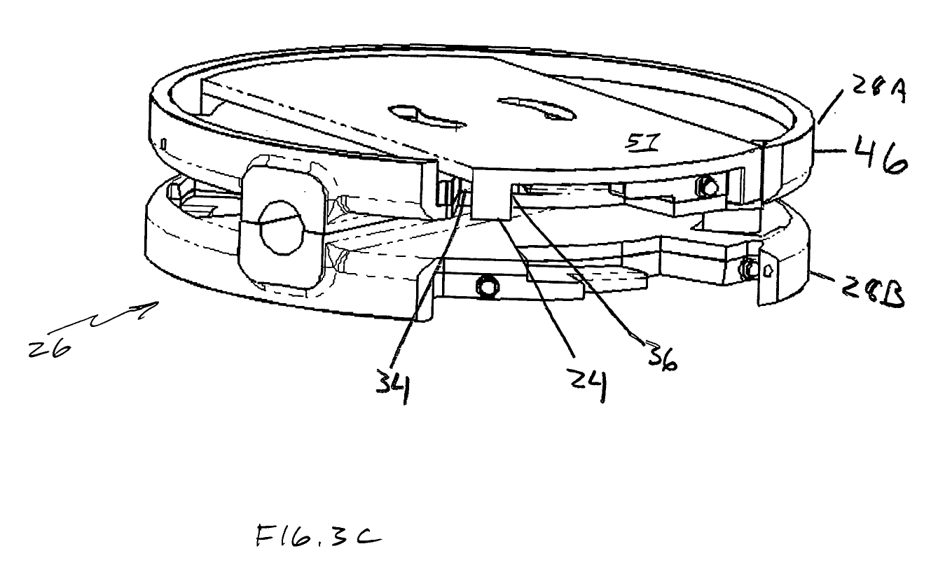

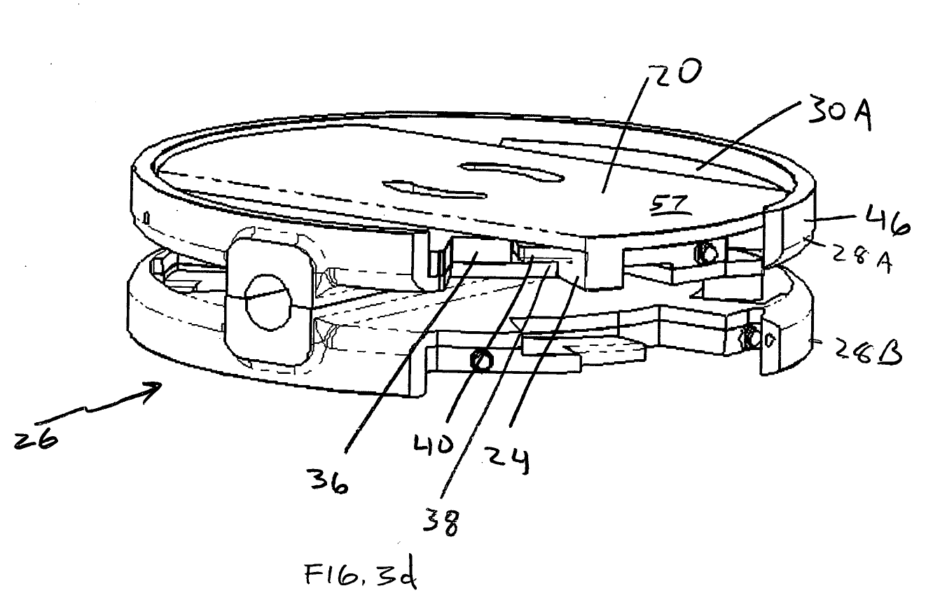

Pedal 26 includes two pedal bodies 28a, 28b and two removable platforms 30a, 30b, one located on each side of pedal 26. All three elements, cleat 20, pedal bodies 28a, 28b and removable platforms 30a, 30b rotate together on pedal shaft 32, which is inserted in pedal shaft entry 33 and which is attached to bicycle crank arm 34, as shown in FIG. 2. Typically cleat 20, pedal bodies 28a, 28b, and removable platforms 30a, 30b are made of a material, such as steel, aluminum, or a plastic composite.

Removable platform 30a includes engaging slots 34 having wide sections 36 with radius R1 and narrow sections 38 having radius R3. Wide sections 36 are adjacent capture portions 40 of removable platform 30a. Capture portions 40 have a radius R2 and a dimension equal to R3-R1. Engaging slots 34 are located and sized to receive engaging hooks 24 on cleat 20, as shown in FIG. 1.

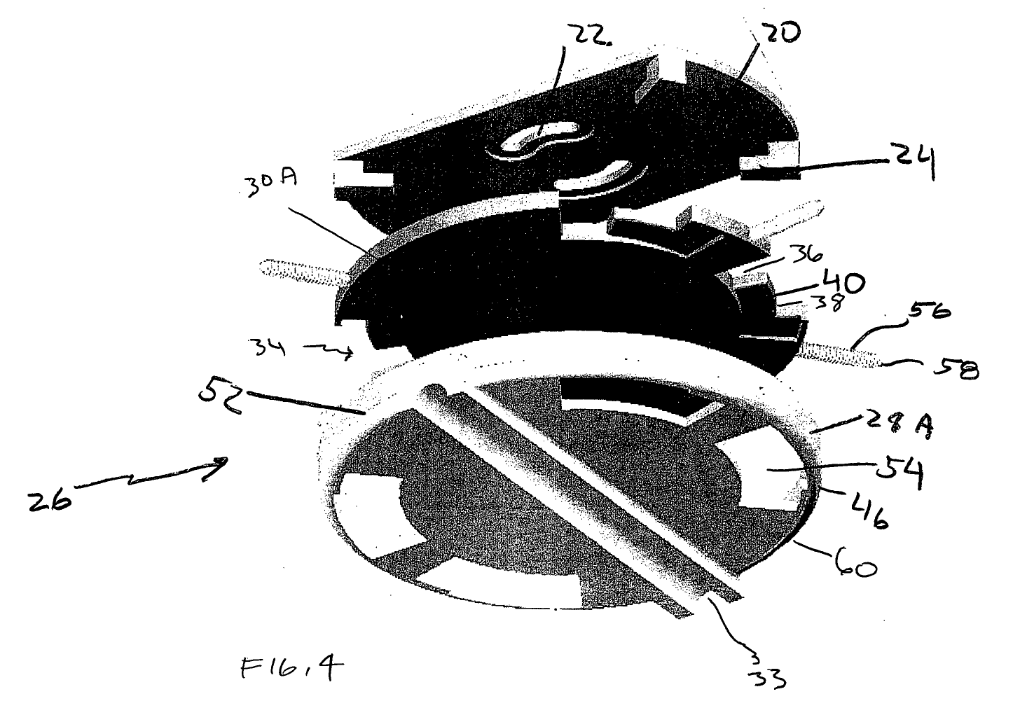

The rider may be resting his or her foot with engaging hooks resting on capture portions 40 of removable platform 30a, as shown in FIG. 3a. Outer surface 42 of cleat 20 is held in position on removable platform 30a by elevated retaining structure 44 of pedal body 28a. Elevated retaining structure 44 has an inner dimension matching outer dimension of outer surface 42 of cleat 20, allowing cleat 20 to rotate within elevated retaining structure 44 but not to slide within. When in the unlocked position with engaging hooks 24 resting on capture portions 40, cleat 20 is also restrained from sliding off pedal 26 by elevated support structure 44. Thus, cleat 20 can twist within cylindrical wall 46 of elevated retaining structure 44 while cylindrical wall 46 retains cleat 20 in place within pedal 26, preventing cleat 20 from sliding off pedal 26.

In the locking procedure, the rider twists the foot, causing engaging hooks 24 to rotate over wide sections 36 of engaging slots 34 in removable platform 30a, as shown in FIG. 3b, in which engaging hooks 24 have been twisted into position and are ready to drop into wide sections 36 of engaging slots 34. A view after engaging hooks 24 have dropped into wide sections 36 of engaging slots 34 is seen in FIG. 3c. Twisting the foot in the reverse direction then causes hooks 24 to twist under capture portions 40 of removable platform 30a, locking clip 20 to pedal 26, as shown in FIG. 3d.

Cleat 20 is unlocked from pedal 26 when the rider twists his or her foot to disengage engaging hooks 24 from under capture portions 40 and move engaging hooks 24 under wide sections 36 of engaging slots 34, as also shown in FIG. 3c. Picking up cleat 20 now removes cleat 20 from wide section 36 of engaging slots 34, as also shown in FIG. 3b. Then twisting again allows engaging hooks 24 to be placed on top of capture portions 40 to avoid re-engaging in wide sections 38 of engaging slots 34, as shown in FIG. 3a.

In one embodiment slots 22 on cleat 20 are “C” shaped enabling adjusting position of cleat 22 on the shoe. By adjusting position of cleat 22 on the shoe the angle for engaging and for disengaging cleat 22 from the locking mechanism, wide sections 36, on platform 30a can be adjusted.

Removable platform 30a typically has four engaging slots 34 which align with J-shaped engaging hooks 24 on cleat 20. The amount of twisting needed to engage engaging hooks 24 with capture portions 40 can be controlled by adjusting the position of cleat 20 on the shoe. This position adjustment can be accomplished with mounting slots 22. Also, by increasing or decreasing dimensions of wide section 36 and narrow section 38 of engaging slot 34 in removable platform 26, the amount of twisting needed can also be adjusted.

Pedal body 28 is cylindrical and has four cutouts 54 cut into bottom surface 56. Cutouts 54 align with engaging slots 34 in removable platform 26. A fewer or a larger number of engaging slots 34 and cutouts 54 can also be used. Cutouts 54 provide space for engaging hooks 24 while they are inserted in wide sections 36 of engaging slots 34.

Cleat 20 thus consists of substantially flat plate 57 with several J-shaped engagement hooks 24 that align with dual width engaging slots 34 in removable platform 30a. In operation, when cleat 20 is not locked into removable platform 30a, engagement hooks 24 may rest on capture portion 40, and cleat 20 may rotate but is constrained from sliding by elevated retaining wall 44. Pedal body 28a and removable platform 30a are aligned so that when engagement hooks 24 are resting on capture portion 40 only a small amount of twist is needed to align engagement hooks 24 with engaging slots 34 so engagement hooks 24 fall into engaging slots 34. When cleat 20 is twisted slightly, J-shaped engaging hooks 24 extend over wide section 36 of engaging slots 34 and drop through wide section 36. Then a twist back locks J-shaped engaging hooks 24 under capture portion 40 of removable platform 30a upon return to their original orientation.

Thus, pedal 26 has two levels of retention or two mechanisms for retaining cleat 20 on pedal 26. Cleat 20 can be locked in place with engaging hooks 24 and engaging slots 34, preventing both relative perpendicular and lateral movement between cleat 20 and pedal 26. Or cleat 20 can be unlocked from pedal 26 allowing the rider to remove his foot from pedal 26. But while his or her foot remains on pedal 26 lateral movement can still be constrained with cylindrical wall 52. Thus, without locking cleat 20, allowing the rider to freely take his or her foot off pedal 26, cleat 20 is still constrained from sliding off pedal 26.

As a further safety measure, even with cleat 20 in the locked position on pedal 26, removable platform 30a can disconnect from pedal body 28 in an emergency, such as during a fall, allowing cleat 20 and removable platform 30a to disengage from pedal body 28 in response to excess force to protect the rider's foot, ankle, and leg from serious injury during the fall.

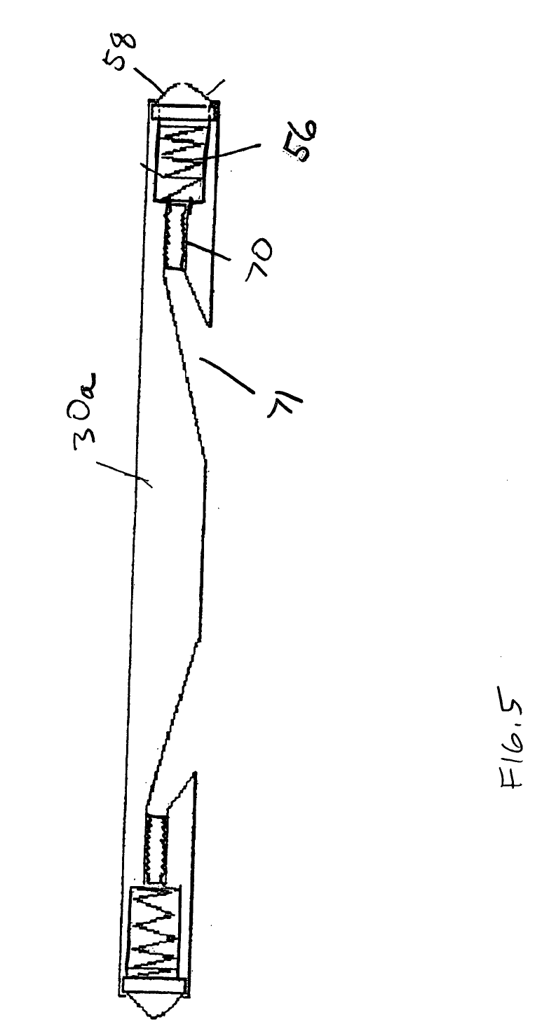

Removable platform 30a is held in place in pedal body 28a with four springs 56 and ball catches 58 that fit into corresponding recesses 60 on inside surface 62 of cylindrical wall 46 of pedal body 28a, as shown in FIGS. 1 and 4. Fewer or more springs 56 and ball catches 58 can be used. These ball catches 58 will release removable platform 30a from pedal body 28a upon the application of abnormal amounts of pressure, such as may occur during a fall. Because ball catches 58 respond to pressure in all directions, the pressure that causes the release can be applied either in the plane of pedal 26 or perpendicular to the plane of pedal 26 and still cause disengagement. Thus, release can be achieved with either of two different mechanisms, a twisting of the foot to disengage cleat 20 from removable platform 30a, as described herein above, or with sufficient pressure acting in any direction to disengage removable platform 30a, with cleat 20 still attached to removable platform 30a, from pedal body 28a.

Spring tension provided to ball catches 58 can be adjusted with adjustment screws 70, as shown in FIG. 4, that are accessible through adjustment screw access hole 71. As adjustment screws 70 are driven in, spring 56 is compressed and spring tension against ball catches 58 increases, increasing the amount of force needed to disconnect removable platform 30a from pedal body 28a. Advantageously, a force perpendicular to surface 56 of pedal 26 surface will work to cause disconnection of removable platform 30a, as will a large twisting force and other forces.

Other configurations of engagement hooks 24 can be used besides the J shaped engagement hooks that extend toward center 72 of removable platform 30a shown in FIG. 1. For example L shaped hooks that extend away from center 72 could be used, and engaging slots 34 would be correspondingly reversed.

While the disclosed methods and systems have been shown and described in connection with illustrated embodiments, various changes may be made therein without departing from the spirit and scope of the invention as defined in the appended claims.

1. An assembly, comprising a cleat and a pedal, said pedal including a locking structure and a retaining wall, said locking structure capable of locking said cleat to said pedal, said retaining wall extending to block said cleat from sliding off said pedal when said cleat is resting on said pedal but not locked in said locking structure.

2. The assembly as recited in claim 1, wherein said locking structure includes a twistable locking structure, wherein said twistable locking structure locks said cleat to said pedal when said cleat is twisted in a first direction and unlocks said cleat from said pedal when said cleat is twisted in a second direction opposite to said first direction.

3. The assembly as recited in claim 2, wherein said locking structure includes a slot, wherein said cleat includes an engaging hook that fits in said slot, wherein twisting said cleat with respect to said locking structure causes said engaging hook to be locked to said locking structure.

4. The assembly as recited in claim 3, wherein said slot has a first section with a first radius and a second section with a second radius, wherein said cleat fits in said first section wherein said twisting causes said hook to be captured.

5. The assembly as recited in claim 3, wherein said engaging hook includes a J shaped region.

6. The assembly as recited in claim 3, wherein location of said engaging hook on said cleat is adjustable.

7. The assembly as recited in claim 3, wherein said pedal includes a pedal surface for receiving said engaging hook.

8. The assembly as recited in claim 3, wherein said pedal includes a pedal body, a removable platform, and a spring loaded quick release mechanism there between, said quick release mechanism for releasably connecting said removable platform to said pedal body, wherein said quick release mechanism releases said removable platform from said pedal body when a sufficient force is applied.

9. The assembly as recited in claim 8, wherein said spring loaded release mechanism includes an adjustable spring.

10. The assembly as recited in claim 1, wherein said pedal further includes a pedal body and a quick release mechanism, said quick release mechanism for disengaging said cleat from said pedal body while said cleat remains locked to said locking structure.

11. The assembly as recited in claim 10, wherein said quick release mechanism comprises a removable platform.

12. The assembly as recited in claim 11, wherein said quick release mechanism further comprising a spring, wherein said removable platform is spring loaded to said pedal body with said spring.

13. The assembly as recited in claim 12, wherein said quick release mechanism further comprises a screw for adjusting spring tension of said spring.

14. The assembly as recited in claim 12, wherein said quick release mechanism further comprises a ball catch that engages in a recess in said pedal body and is held in said recess with said spring tension.

15. The assembly as recited in claim 1, wherein said pedal includes a pedal surface, said locking structure extending below said pedal surface, said retaining wall extending above said pedal surface.

16. The assembly as recited in claim 15, wherein said pedal further includes a pedal body and a removable platform releasably connected to said pedal body, said surface being a surface of said removable platform.

17. The assembly as recited in claim 16, wherein said removable platform includes said locking structure.

18. The assembly as recited in claim 1, wherein said retaining wall comprises a ring shaped wall.

19. The assembly as recited in claim 18, wherein said retaining wall extends fully around said cleat when said cleat is on said pedal.

20. The assembly as recited in claim 1, wherein said cleat has an outside dimension and wherein said retaining wall has an inner dimension, and wherein said outside dimension is about equal to or less than said inner dimension.

21. The assembly as recited in claim 20, wherein said outside dimension and said inner dimension are set to prevent sliding of said cleat in said pedal while permitting rotation of said cleat in said pedal.

22. An assembly, comprising a cleat and a pedal, wherein said pedal includes a pedal body, a removable platform, and a releasing mechansim there between, said platform releasably connected to said pedal body, said releasing mechansim set to release said platform from said pedal body when a sufficient force is applied.

23. The assembly as recited in claim 22, further comprising an adjusting mechanism for changing magnitude of force sufficient to release said removable platform from said pedal body.

24. The assembly as recited in claim 22, wherein said releasing mechanism includes a spring and a ball catch.

25. The assembly as recited in claim 22, wherein said platform further comprises a cleat locking and unlocking structure.

26. An assembly, comprising a cleat and a pedal, wherein said pedal includes a surface having a cleat locking and unlocking structure, said cleat locking and unlocking structure including a dual width slot.

27. The assembly as recited in claim 26, wherein said pedal further comprises a pedal body, a removable platform, and a quick release mechanism, said surface being a surface of said platform, said quick release mechanism disconnecting said platform from said pedal body when a sufficient force is applied.

28. The assembly as recited in claim 26, wherein said quick release mechanism comprises a spring loaded device.

29. The assembly as recited in claim 28, wherein said quick release mechanism comprises an adjusting screw for adjusting spring tension of said spring loaded device

30. The assembly as recited in claim 28, wherein said quick release mechanism comprises a ball catch.

31. An assembly, comprising a cleat and a pedal, said pedal including a first retaining mechanism and a second retaining mechanism, said first retaining mechanism for locking said cleat to said pedal, said second retaining mechanism for holding said cleat on said pedal when said first mechanism is not used.

32. The assembly as recited in claim 31, wherein said second mechanism permits relative rotation between said cleat and said pedal and prevents said cleat from sliding off said pedal.

33. An assembly as recited in claim 31, wherein said cleat for mounting on a shoe, said cleat comprising a C shaped adjustment slot for adjusting position of said cleat on said shoe, wherein adjusting position of said cleat on said shoe changes angle for disengaging said cleat from said first locking mechanism.
